(19) United States
(12) Patent Application Publication
(10) Pub. No.: US 2026/0162514 A1
(43) Pub. Date: Jun. 11, 2026

(54) SYSTEM AND METHOD TO LOCATE A VEHICLE ACCESS DEVICE USING A SECOND VEHICLE ACCESS DEVICE

(71) Applicant: FCA US LLC, Auburn Hills, MI (US)

(72) Inventors: Jaycil Z Varghese, Auburn Hills, MI (US); Ahmad Saleh, Auburn Hills, MI (US)

(21) Appl. No.: 18/976,901

(22) Filed: Dec. 11, 2024

(51) Int. Cl. G08B 21/24; G07C 9/00; G08B 7/06; G08B 25/10; H04B 17/318

(52) U.S. Cl. CPC G08B 21/24; G07C 9/00309; G08B 7/06; G08B 25/10; H04B 17/318; G07C 2009/00793; G07C 2009/00984; G07C 2209/63

(57) ABSTRACT

A method for locating a vehicle access device using a second vehicle access device may include the steps of prompting a search for the vehicle access device, detecting a signal of the vehicle access device using the second vehicle access device, and determining a location of the vehicle access device. The location of the vehicle access device may be determined based at least partially on the signal strength between the vehicle access device and the second vehicle access device, the GPS location of the second vehicle access device, or a previous known location of the vehicle access device.

### FIELD

The present disclosure relates to vehicle access devices and a method for locating a vehicle access device using a second vehicle access device.

### BACKGROUND

Vehicles may use key fobs to operate one or more vehicle functions such as unlocking or locking doors, opening, or closing doors, or starting a vehicle's ignition. However, key fobs are generally small for portability and may be misplaced by a user of the vehicle. When a key fob is lost, the user must attempt to remember where it was placed, often requiring a search of the vehicle interior, the environment near the vehicle, and/or other locations the user has traveled to with the key fob.

### SUMMARY

In at least some implementations, a method for locating a vehicle access device may include detecting a signal from a first vehicle access device using a second vehicle access device, and determining the location of the first vehicle access device as a function of the strength of the signal received at the second vehicle access device.

In at least some implementations, the step of detecting a signal from the first vehicle access device is accomplished by either the first vehicle access device or the second vehicle access device sending a wireless communication and the other of the first vehicle access device or the second vehicle access device receiving the wireless communication.

In at least some implementations, the wireless communication is one or more of cellular, ultra-wideband (UWB), WiFi, satellite communications, radio, or Bluetooth.

In at least some implementations, determining the location of the first vehicle access device is at least partially based on the time the signal was detected by the second vehicle access device, the strength of the signal detected by the second vehicle access device, the location of the second vehicle access device at the time the signal is detected by the second vehicle access device, or a combination of two or more of the time the signal was detected by the second vehicle access device, the time the signal was sent by the first vehicle access device, the strength of the signal detected by the second vehicle access device, the location of the second vehicle access device at the time the signal is detected by the second vehicle access device.

In at least some implementations, the location of the second vehicle access device is determined using the location of an external device.

In at least some implementations, subsequent to the step of determining the location of the first vehicle access device, the method further comprises a step of communicating the location of the first vehicle access device.

In at least some implementations, the step of communicating the location of the first vehicle access device includes visually, audibly, or tactilely communicating the location of the first vehicle access device through an external device, the second vehicle access device, or a user interface of a vehicle.

In at least some implementations, prior to detecting a signal from the first vehicle access device using a second vehicle access device, the first vehicle access device is determined to not be near or within a vehicle by one or more access device sensors.

In at least some implementations, when in either the step of detecting a signal from the first vehicle access device using a second vehicle access device or the step of determining the location of the first vehicle access device, the signal is not detected by the second vehicle access device or the location of the first vehicle access device cannot be determined, the method further comprises a step of communicating that the location of the first vehicle access device could not be determined.

In at least some implementations, the step of communicating that the location of the first vehicle access device could not be determined includes visually, audibly, or tactilely communicating that the location of the first vehicle access device could not be determined through an external device, the second vehicle access device, or a user interface of a vehicle.

In at least some implementations, a method for locating a vehicle access device includes prompting a search for a first vehicle access device, determining a previous known location of the first vehicle access device, determining if a signal from the first vehicle access device is detected by an access device sensor of a vehicle, when a signal is not detected from the first vehicle access device, detecting a signal from the first vehicle access device using a second vehicle access device, and determining the location of the first vehicle access device as a function of the signal received by the second vehicle access device.

In at least some implementations, prompting a search for the first vehicle access device is done by a user or by a control system of the vehicle.

In at least some implementations, the control system may prompt the search for the first vehicle access device based at least partially on door position of the vehicle, window position of the vehicle, drivetrain position of the vehicle, or ignition position of the vehicle.

In at least some implementations, determining a previous known location of the first vehicle access device includes storing GPS coordinates in a memory of a control system where the first vehicle access device and an access device sensor or the first vehicle access device and a second vehicle access device previously communicated.

In at least some implementations, the step of detecting a signal from a first vehicle access device using a second vehicle access device is accomplished by either the first vehicle access device or the second vehicle access device sending wireless communication and the other of the first vehicle access device or the second vehicle access device receiving wireless communication.

In at least some implementations, the wireless communication is one or more of cellular, WiFi, ultra-wideband (UWB), satellite communications, radio, or Bluetooth.

In at least some implementations, determining the location of the first vehicle access device is at least partially based on strength of the signal received by the second vehicle access device.

In at least some implementations, determining the location of the first vehicle access device is at least partially based on the time the signal was detected by the second vehicle access device, the time the signal was sent by the first vehicle access device, the strength of the signal detected by the second vehicle access device, or the location of the second vehicle access device at the time the signal is detected by the second vehicle access device.

In at least some implementations, subsequent to the step of determining the location of the first vehicle access device, the method further comprises a step of communicating the location of the first vehicle access device.

In at least some implementations, the step of communicating the location of the first vehicle access device includes visually, audibly, or tactilely communicating the location of the first vehicle access device through an external device, the second vehicle access device, or a user interface of a vehicle.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a schematic of a system to locate a vehicle access device, showing the access device within the vehicle;

FIG. 2 is a schematic of the system to locate the vehicle access device, showing the access device outside of the vehicle;

FIG. 3 is a schematic of the system to locate the vehicle access device with the access device within the vehicle;

FIG. 4 is a schematic of the system to locate the vehicle access device with the access device outside the vehicle;

FIG. 5 is a schematic of the system to locate the vehicle access device with a second vehicle access device;

FIG. 6 is a schematic of the system to locate the vehicle access device with the second vehicle access device; and

FIG. 7 is a flowchart depicting a method for locating the vehicle access device.

### DETAILED DESCRIPTION

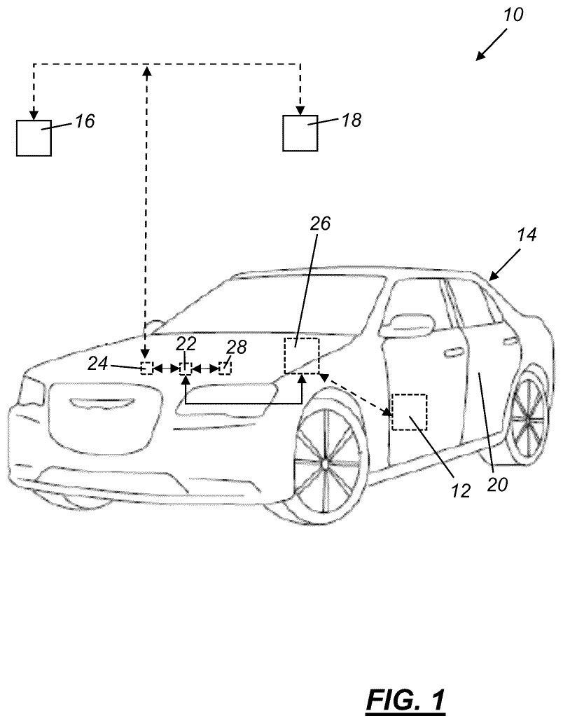

Referring in more detail to the drawings, FIGS. 1-6 show a system 10 for locating a vehicle access device 12. The vehicle access device 12 may be, by way of a non-limiting example, a so-called “key fob” or other wireless device by which, by way of non-limiting examples, door locks may be remotely operated, a vehicle ignition actuated or enabled, and other vehicle functions performed as commanded by a user. The system may include the vehicle 14, the vehicle access device 12, an external device 16 by which a user can send and receive communications, and a network/remote server 18 by which the external device 16 can communicate with the vehicle 14.

The vehicle 14 may include a body 20 with body panels, doors, locks for the doors, a control system 22, a communications device 24 with a transmitter and a receiver, one or more access device sensors 26, and a user interface 28. The vehicle transmitter is capable of transmitting wireless communications and the vehicle receiver is capable of receiving wireless communications. For example, wireless communications may be cellular, WiFi, satellite communications, radio, Bluetooth, or others. The communications device 24 may be defined by separate components (e.g. for the transmitter and receiver) or integrated into a single component depending on the embodiment.

The vehicle control system 22 is in communication with the communications device 24 such that the control system 22 can transmit and receive signals and information via the communications device 24. The control system 22 has one or more controllers or processors, memory and instructions or programs stored in the memory or otherwise accessible by the processor(s). In some implementations, the control system 22 may have or be defined by a plurality of vehicle controllers, such as but not limited to, an infotainment module, a telematics module, body control module, powertrain control module, and the like, and the controllers may be independent or networked to each other. Each of the controllers may communicate with one or more vehicle components or system components. The communications device 24 is in communication with the control system 22, and is capable of receiving communication from the vehicle access device 12 and relaying that communication to the control system 22 to permit use of the vehicle access device 12 with the vehicle 14.

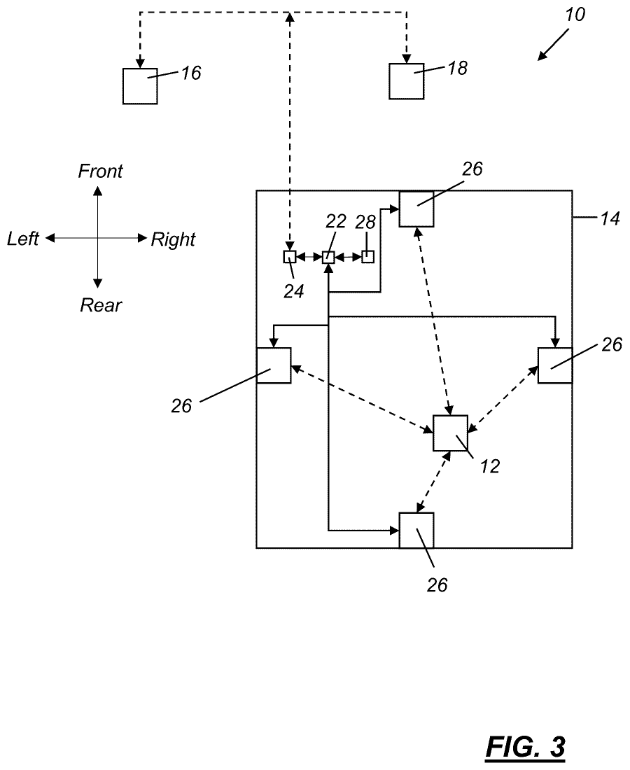

The one or more access device sensors 26 may be positioned on or within the vehicle 14 and each may have a receiver capable of receiving signals or communications transmitted from the vehicle access device 12 and determining the signal strength of the communication from the vehicle access device 12. Communication to and/or from the access device sensors 26 can be any form of wireless communication such as, but not limited to short-range or long-range communications, such as cellular, ultra-wideband (UWB). near-field communications, Bluetooth, WiFi, satellite communications, radio, or others. As shown in FIG. 3, four vehicle access sensors 26 are spaced apart from each other, and positioned at front, rear, left, and right positions of the vehicle 14. One or more of the access device sensors 26 may simultaneously receive communication from the vehicle access device 12.

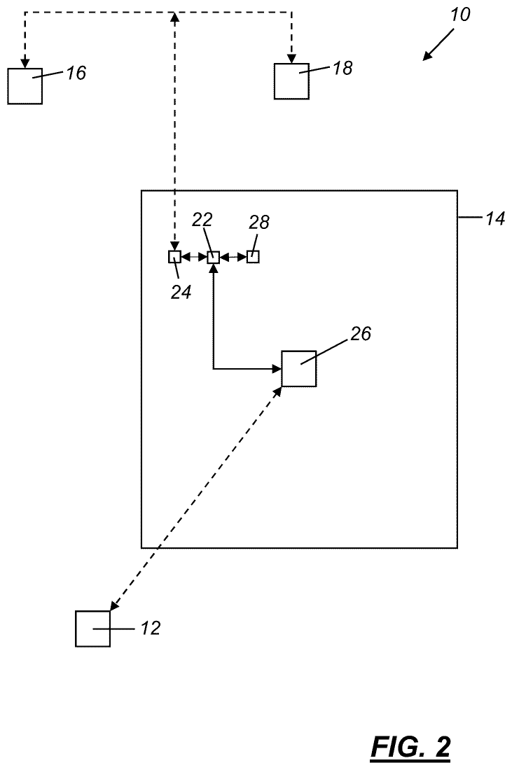

Based upon the signal strength of communication received at each of the one or more access device sensors 26 or the elapsed time between sending and receiving the signal or communication the approximate distance from the vehicle access device 12 relative to each of the one or more access device sensors 26 may be determined. Using known locations of the access device sensors 26 and the signal strength at each access device sensor 26, the approximate location of the vehicle access device 12 can be determined. In FIGS. 1-2, a single access device sensor 26 is positioned centrally in the vehicle 14, although the access device sensor 26 may be located anywhere on or within the vehicle 14, as desired. In FIGS. 3-6, four access device sensors 26 are positioned at front, side, and rear positions of the vehicle 14. However, other quantities and positions of access device sensors 26 may be implemented as needed.

The user interface 28 may be part of a vehicle infotainment system, and may include a display visible by one or more vehicle occupants within the interior of the vehicle 14, a tactile feedback system capable of tactilely communicating information to a user, or a speaker capable of audibly communicating information to the user. The control system 22 may be in communication with the user interface 28 to provide various multimedia content and information to vehicle occupants, and to provide the user interface 28 by which a user can enter information via the display or related inputs. In at least some implementations, user input via the user interface 28 may be provided through a touch-sensitive display, allowing vehicle occupant(s) to navigate through menus, adjust vehicle settings, and control features by tapping or swiping on the touchscreen. Some implementations may utilize physical controls to recognize vehicle occupant input such as button, knobs, or dials positioned within the interior of the vehicle. Other implementations may use voice recognition through integrated voice control systems allowing vehicle occupant(s) to operate vehicle functions using voice commands.

The vehicle access device 12 (e.g. key fob or external device such as a mobile phone) may have a body in which is housed a controller, a transmitter and one or more inputs via which the user can input commands to be sent to the vehicle communications device and recognized by the vehicle control system 22. The inputs(s) may be provided on the body in the form of buttons, switches, capacitive touch, a touch screen, voice recognition, motion sensors, or other user interface, as desired.

The vehicle access device controller and transmitter are powered by a battery and capable of sending signals to the vehicle control system 22 in response to actuation of one or more of the user inputs. Communication from the vehicle access device transmitter can be any form of wireless communication such as, but not limited to short-range or long-range communications, such as cellular, ultra-wideband (UWB), near-field communications, Bluetooth, WiFi, satellite communications, radio, or others. When an input of the vehicle access device 12 is actuated by a user, the access device transmitter sends an output to and recognizable by the vehicle control system 22. For example, actuation of a first input of the vehicle access device 12 may send an output to the control system 22 to unlock one or more vehicle doors, actuation of a second input may cause a vehicle engine to start, actuation of a third input may cause a vehicle trunk or liftgate to open, and the like. In some implementations the vehicle access device 12 may have a speaker, a vibrating motor, or a display to provide audio, tactile, or visual feedback to the user.

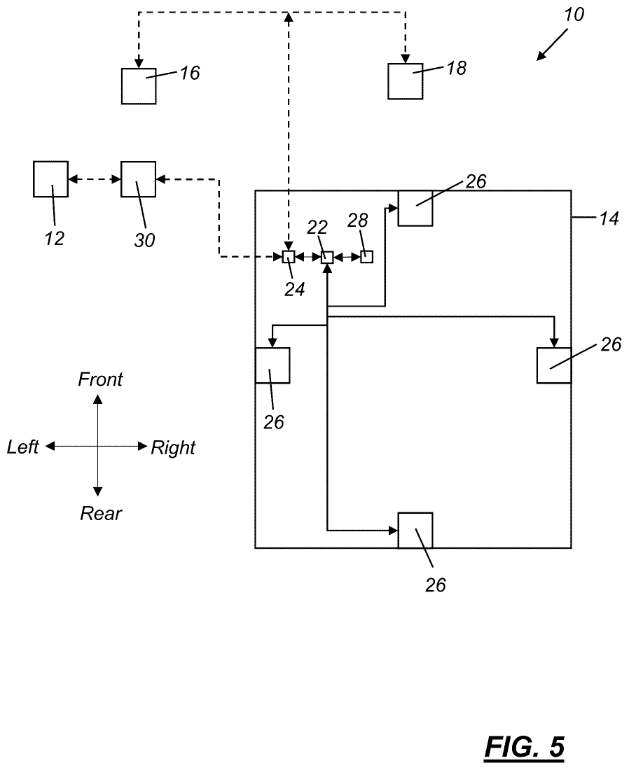

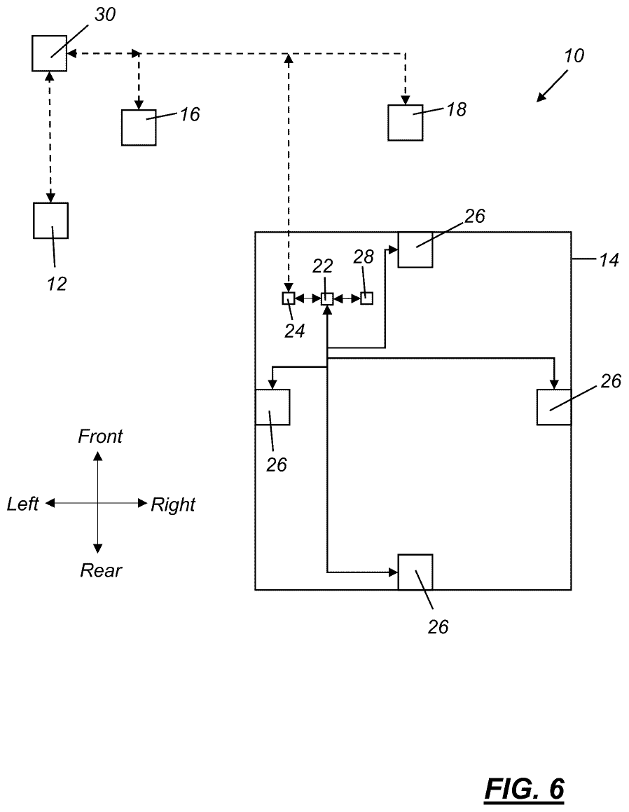

In some implementations, as shown in FIGS. 5-6, a second vehicle access device 30 may be in communication with the vehicle 14 and/or the vehicle access device 30 (hereafter called the first vehicle access device 12). The second vehicle access 30 device may be the same or similar in construction to the first vehicle access device 12. Or, in implementations where the external device 16 is not acting as the first vehicle access device 12, the second vehicle access device 30 may be the external device 16 and may be capable of communicating with the vehicle 14 to control at least some vehicle functions, so that the external device 16 can perform both the functions of the external device 16 and the second vehicle access device 30. The second vehicle access device 30 may be capable of detecting communication from the first vehicle access device 12 and determining the signal strength of the communication from the first vehicle access device 12. The distance of the second vehicle access device 30 from the first vehicle access device 12 may be approximated based on a pre-established relationship between the signal strength of the communication received from the first vehicle access device 12. The second vehicle access device 30 may communicate with the vehicle access device 12, an external device 16, a remote server 18, or the vehicle communications device 24.

The external device 16 may be owned or controlled by the vehicle owner or an authorized user of the vehicle 14 and may be a computer, smartphone, tablet, or other electronic device permitting communication to and from the user. The external device 16 has one or more processors, memory, and instructions or programs stored in the memory or otherwise accessible by the processors. The external device 16 has a communication unit with a device transmitter capable of transmitting signals wirelessly, and a device receiver capable of receiving signals wirelessly. Communication to and from the external device 16 can be any form of wireless communication such as, but not limited to cellular, ultra-wideband (UWB), WiFi, satellite communications, radio, or others. The external device 16 may have GPS capability to determine the real-time location of the external device 16. Previous locations of the external device 16 may be saved in the memory of the external device 16 and displayed to a user on a screen or communicated to the vehicle 14 or the remote server 18.

The external device 16 may include a screen capable of displaying information to a user, a tactile feedback system capable of tactilely communicating information to a user, or a speaker capable of audibly communicating information to the user. The one or more processors are in communication with the screen and the external device 16 may include an input system capable of obtaining user input and communicating the user input to the one or more processors. In some implementations, the external device 16 may perform one or more functions of the vehicle access device 12 to control aspects of the vehicle 14. The external device 16 may communicate directly with the communications device 24 of the vehicle, or the remote server 18 to control the vehicle 14.

In at least some embodiments, the vehicle control system 22 and/or the external device 16 may communicate with the remote server 18, which may be part of a backend portion of a cloud-based system, and may include one or more processors, memory/data storage and programs to implement the functions required of the remote server 18. The remote server 18 may facilitate communication between the vehicle communications device 24 and the external device 16. The remote server 18 may be capable of receiving and transmitting communications through wireless communication such as, but not limited to, cellular, ultra-wideband (UWB), WiFi, satellite communications, radio, or others. Upon receiving communication from either the external device 16 or the vehicle 14, the remote server 18 may handle the request which may include querying local or remote memory, performing computations, or executing computer code. After handling the request, the remote server 18 formats and sends communications to the intended destination, which may include either the external device 16 or the vehicle control system 22. The intended destination may receive the communication and, in some implementations, send an acknowledgement of receipt back to the remote server 18.

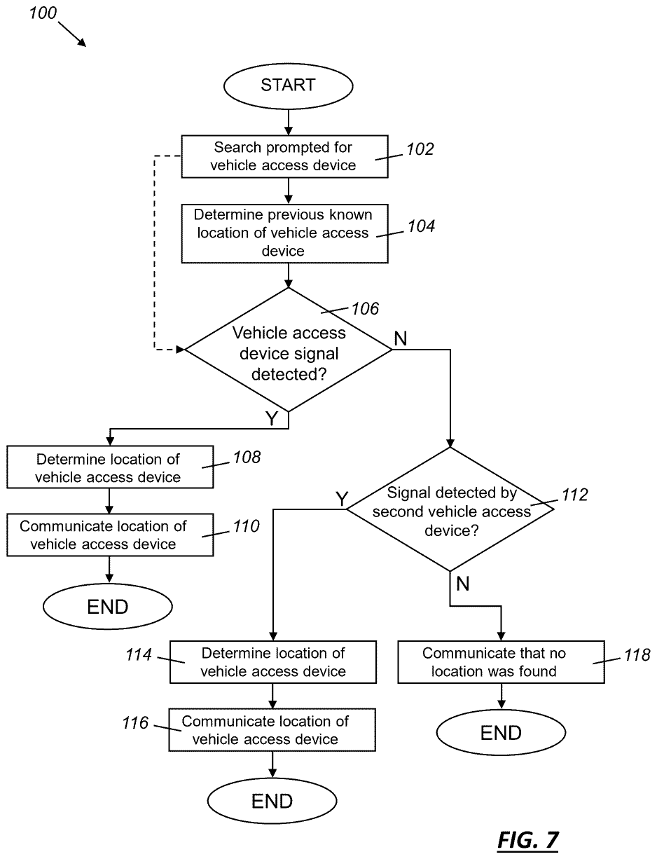

A method 100 for locating a vehicle access device 12 is shown in FIG. 7. In step 102, a user or the control system 22 of the vehicle 14 may prompt the vehicle 14 to search for a lost or misplaced vehicle access device 12. The user may use the user interface 28 or the external device 16 to begin the prompt. To begin a search for the vehicle access device 12 after input from the user, the user interface 28 may communicate with the control system 22 or the external device 16 may communicate with the control system 22 by way of the communications device 24 or by way of the remote server 18. Alternatively, the control system 22 of the vehicle 14 may prompt a search for the vehicle access device 12 when certain vehicle conditions are met. For example, the vehicle conditions may be when a door is opened and shut while the ignition or power of the vehicle 14 is switched off. Other vehicle conditions such as the position of one or more windows of the vehicle 14, the position of the vehicle's drivetrain (park, drive, reverse, etc.), or the GPS location of the vehicle 14 may prompt a search for the vehicle access device 12. Depending on the implementation, the method 100 may progress to either step 104 if the user requires a previous location of the vehicle access device 12 or step 106 if the user knows the previous location of the vehicle access device 12.

In step 104, a previous known location of the vehicle access device 12 is determined. The times and locations that the vehicle access device 12 is detected by the one or more access device sensors 26 or used to control one or more vehicle functions may be periodically or continuously logged by the memory of the control system 22. The location may be GPS coordinates of the vehicle's location at the time the vehicle access device 12 is detected. A previous time and/or location, possibly the most recent time and the location associated with that time, may be communicated to the user through the user interface 28 or the external device 16 by way of direct communication, from the control system 22 to the communications system 24 to the external device 16, or indirect communication, from the control system 22 to the communications device 24 to the remote server 18 to the external device 16. Upon receiving the previous time and/or location that the vehicle access device 12 was near the vehicle 14, the user may travel with the vehicle 14 to that location to find the vehicle access device 12 (using the second vehicle access device 30 that may be the external device 16 or a separate device from the external device 16). Upon reaching the location that the vehicle access device 12 was known to previously be near the vehicle 14, the method proceeds to step 106.

In step 106, the one or more access device sensors 26 of the vehicle 14 attempt to receive communication from the vehicle access device 12 to determine whether the vehicle access device 12 is near the vehicle 14 (within range of the one or more access device sensors 26). The one or more access device sensors 26 may await communication from the vehicle access device 12, or may send communication to be received by the vehicle access device 12. Upon receiving communication from the one or more access device sensors 26, the vehicle access device 12 may confirm receipt by sending communication back to the one or more access device sensors 26 or to the communications device 24. If communication between the one or more access device sensors 24 and the vehicle access device 12 is possible, indicating that the vehicle access device 12 is near the vehicle 14, the method 100 advances to step 108. If communication between the one or more access device sensors 26 and the vehicle access device 12 is not possible the method 100 advances to step 112.

In step 108, the approximate location of the vehicle access device 12 relative to the vehicle 14 (e.g. the access device sensors of the vehicle) is determined. In FIGS. 1-2, the vehicle 14 has a single access device sensor 26. As shown by FIG. 1, the vehicle access device 12 is within the vehicle 14 and in range of the access device sensor 26 and may communicate with the access device sensor 26. FIG. 2 shows the vehicle access device 12 within range of the access device sensor 26, but outside of the vehicle 14. The control system 22 may estimate the distance the vehicle access device 12 is from the access device sensor 26 based on the strength of the communication (signal) from the vehicle access device 12 to the access device sensor 26 and based on the position of the access device sensor 26 relative to the vehicle 14. The distance from the vehicle access device 12 to the access device sensor 26 represents a radius from the access device sensor 26 that the vehicle access device 12 is located within. Therefore, the control system 22 may differentiate between the scenarios shown in FIGS. 1-2, where the vehicle access device 12 may be within the vehicle 14 (FIG. 1) or outside of the vehicle 14 (FIG. 2).

The distance from the vehicle access device 12 to the access device sensor 26 may also be determined based on the elapsed time between sending and receiving communication between the vehicle access device 12 and the access device sensor 26. When the speed the communication travels is known, which in some implementations may be the speed of light (approximately 3*108 m/s), the time between sending and receiving communication may be multiplied by the speed of the communication to determine the distance from the vehicle access device 12 to the access device sensor 26. For example, the vehicle 14 may send a first signal at a time of T₀. The vehicle access device 12 may receive the first signal at a time of T₁. By subtracting T₁ by T₀ and multiplying by the speed of travel of the signal, the distance, in units of the speed of travel may be obtained. As another example, the vehicle access device 12 may send a second signal at T₂. The vehicle 14 may receive the second signal from the vehicle access device 12 at T₃. The time elapsed between T₃ and T₀ is the time of travel of the first signal and the second signal plus any processing time of the vehicle access device 12 in receiving the first signal and sending the second signal. The time elapsed between T₂ and T₁ is the processing time of the vehicle access device 12 between receiving the first signal and sending the second signal. The distance between the vehicle access device 12 and the access device sensor 26 of the vehicle 14 may be determined by subtracting the time of travel of the signal plus any processing time of the vehicle access device 12 in receiving the first signal and sending the second signal by the processing time of the vehicle access device 12 in receiving the first signal and sending the second signal, multiplying by the speed of travel of the signal, and dividing by two to account for the first signal and second signal each traveling the distance to and from the vehicle access device 12. The distance may be represented by the following formula:

$${D}_{1} = \frac{{T}_{3} - {T}_{0} - ( {T}_{2} - {T}_{1} )}{2} * ( speed of travel of signal )$$

When the distance calculated from the elapsed time is less than a predetermined threshold, the vehicle access device may be determined to be within the vehicle (as shown by FIG. 1). When the distance calculated from the elapsed time is greater than a predetermined threshold, the vehicle access device may be determined to be outside of the vehicle (as shown by FIG. 2).

To further confirm the distance between the vehicle access device 12 and the access device sensor 26, the vehicle 14 may send a third signal to the vehicle access device 12 at time T₄. The vehicle access device 12 may receive the third signal at time T₅. The time elapsed between Ts and T₂ is the time of travel of the second signal and the third signal plus any processing time of the vehicle 14 in receiving the second signal and sending the third signal. The time elapsed between T₄ and Ts is the processing time of the vehicle 14 in receiving the second signal and sending the third signal. The distance between the vehicle access device 12 and the access device sensor 26 of the vehicle 14 may be determined by subtracting the time of travel of the signal plus any processing time of the vehicle in receiving the second signal and sending the third signal by the processing time of the vehicle 14 in receiving the second signal and sending the third signal, multiplying by the speed of travel of the signal, and dividing by two to account for the second signal and third signal each traveling the distance to and from the vehicle access device 12. The distance may be represented by the following formula:

$${D}_{2} = \frac{{T}_{5} - {T}_{2} - ( {T}_{4} - {T}_{3} )}{2} * ( speed of travel of signal )$$

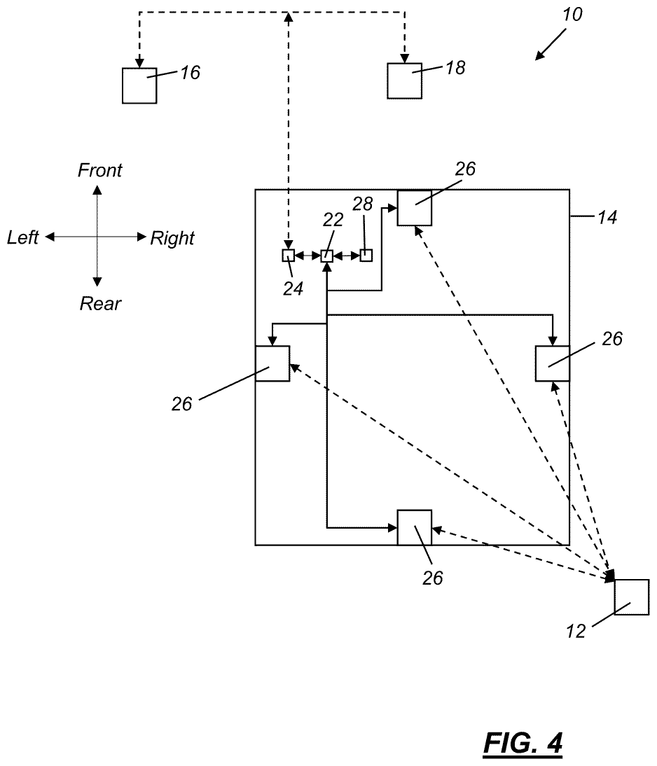

In the example shown in FIGS. 3-4, the vehicle 14 has four access device sensors 26 positioned at known locations of the vehicle 14. The strength of a signal or the time between sending and receiving the signal or communication the approximate distance from the vehicle access device 12 received at each sensor 26 after a communication from the access device 12 is a function of the distance of the vehicle access device 12 from each sensor 26. Generally, the greater the signal strength, or the greater the time elapsed between sending and receiving the communication/signal, the closer the vehicle access device 12 is to the access device sensor 26. Therefore, in implementations having multiple access device sensors 26, by comparing the signal strengths at each access device sensor 26, or elapsed time between sending and receiving the commination/signal at the access device sensors 26 and the vehicle access device 12, the approximate distance from each access device sensor can be determined using, for example, a predetermined relationship between signal strength and distance, or by multiplying the elapsed time between sending and receiving the communication/signal by the speed of travel of the communication/signal as previously described. Based on the estimated distance the vehicle access device 12 is from each access device sensor 26, the control system 22 may differentiate between when the vehicle access device 12 is within the vehicle 14 (FIG. 3) and outside of the vehicle 14 (FIG. 4).

The approximate location of the vehicle access device 12 may be further narrowed to be in a specific portion of the vehicle 14 if the vehicle access device 12 is determined to be within the vehicle 14 or a specific direction from the vehicle 14 if the vehicle access device 12 is determined to be outside of the vehicle 14. For example, in FIGS. 1-2, the approximate distance between the vehicle access device 14 to the single access device sensor 26 is known. Therefore, the vehicle access device 26 is located somewhere at the known distance within an area circumferentially surrounding the access device sensor 26. Another example, as shown in FIG. 3, if all access device sensors 26 detect the vehicle access device 12 within a predetermined distance, indicating the vehicle access device 12 is within the vehicle 14, and the strongest signal is received by the rear and right access device sensors the control system 22 determines that the vehicle access device 26 is in a rear-right position within the vehicle 14.

In yet another example, as shown in FIG. 4, if the received signal strength is greater at the access device sensor 26 positioned at the rear of the vehicle 14 and the access device sensor positioned at the right of the vehicle 14 and the differential between the signal strength of the strongest signal received by one of the access device sensors 26 and the weakest signal received by one of the access device sensors 26 is beyond a predetermined threshold, the vehicle access device is determined to be outside of the vehicle 14 and generally in a rear-right direction. In this example, any differential between the access device sensor 26 positioned at the rear of the vehicle 14 and the access device sensor 26 positioned at the right of the vehicle 14 can determine whether the vehicle access device 12 is closer to the vehicle 14 in either the rear or right directions. Logic, like that applied in the previous examples, may be implemented by the control system 22 to determine any location of the vehicle access device 12 when the vehicle access device 12 is within a range of the one or more access device sensors 26.

Furthermore, as shown in FIG. 4, the elapsed time of sending and receiving communication between the access device sensors 26 and the vehicle access device 12 may be used to determine the specific location of the vehicle access device 12 relative to the vehicle 14. For example, after the distance of the vehicle access device 12 from each access device sensor 26 is determined, the distances can be compared to determine the location of the vehicle access device. In FIG. 4, the rear and right access device sensors 26 would have shorter elapsed time of communication compared to the front and left access device sensors 26. This indicates that the vehicle access device 12 is closer to the rear and right access device sensors, and therefore, positioned rear and right from the vehicle 14.

In some implementations, when the vehicle access device 12 is within the vehicle 14 and one or more conditions, such as those described earlier, indicate that the vehicle access device 12 may be unintentionally left behind in the vehicle 14, the control system 22 may alert the user via the user interface 28, the external device 16, or the vehicle access device 12 if the vehicle access device 12 is equipped to do so. This may proactively seek to prevent a user from unintentionally leaving a vehicle access device 12 in the vehicle 14.

In step 110, after the approximate location of the vehicle access device 12 has been determined, the approximate location is communicated to a user. The control system 22 may display information about the location of the vehicle access device 12 on the user interface 28, via a display or other vehicle system, to the user. Alternatively, the control system 22 may send the location through the communications device 22 directly to the external device 16 via wireless communication, or indirectly to the external device 16 via the remote server 18 to inform the user of the location of the vehicle access device 12. Upon successfully locating the vehicle access device 12, which may be determined by bringing the vehicle access device 12 within a certain distance of the vehicle 14, activating a button or function of the vehicle access device 12, or by receiving confirmation from the user that the vehicle access device 12 has been successfully located (through the external device 16, user interface 28, or by other means), or by other interaction(s) between the vehicle access device 12 and the vehicle 14, the method 100 ends.

If in step 106, the one or more access device sensors 26 are unable to receive a signal from the vehicle access device 12, then the method 100 continues from step 106 to step 112. In step 112, the second vehicle access device 30 may be carried by the user beyond the range of the one or more access device sensors 26 and the second vehicle access device 30 may be used to send a transmission capable of being received by the first vehicle access device 12 to locate the first vehicle access device 12. In at least some implementations, this is done by actuating one or more inputs of the second vehicle access device 30 which causes a signal to be emitted from the second vehicle access device 30. If the first vehicle access device 12 is within range and receives the signal, the first vehicle access device 12 (e.g. the controller thereof) is arranged to cause the first vehicle access device 12 to emit/transmit a responsive signal capable of being received by the second vehicle access device 30. If the second vehicle access device 30 receives communication from the first vehicle access device 12, in step 114, the time and signal strength of the communication or the elapsed time between sending and receiving the signal as previously described herein or communication may be stored in the second vehicle access device's memory. That is, the formula and methods set out for determining the location of the vehicle access device 12 using access device sensors 26 may be used to determine the distance between the vehicle access device 12 and the second vehicle access device 30 by communication sent and received between the vehicle access device 12 and the second vehicle access device 30. Additional information such as, the time, GPS location of the second vehicle access device 30 (if available), and signal strength of the communication received by the second vehicle access device 30 may be sent to the vehicle 14 to help in determining the location of the first vehicle access device 12.

Thus, in at least some implementations, a user will not immediately know if or when the second access device 30 has received a signal from the first access device 12. The user can walk or otherwise move around an area of interest (e.g. a search area) while seeking to elicit a response or otherwise receive a signal from the first vehicle access device 12, and then the user can return to the vehicle 14 to upload information from the second vehicle access device 30 to the vehicle 14 or to an external device 16 or to the remote server 18, for example and as noted below.

To upload information to the vehicle 14, for example, as shown in FIG. 5, when the second vehicle access device 30 returns to within range of the one or more access device sensors 26, information stored by the second vehicle access device 30 may be communicated to the vehicle 14 (e.g. via the access device sensors 26 and/or the communications device 24), so that the control system 22 can determine the location of the first vehicle access device 12. In another example, as shown in FIG. 6, the second vehicle access device 30 may communicate information from a search for the first access device 12 directly to the remote server 18 via wireless communication or indirectly to the remote server 18 through communication to the external device 16 or to the vehicle control system 22 which in turn communicates with the remote server 18. The control system 22 and/or programs at the remote server 18 or at the external device 16 may then overlay GPS location data with the time, signal strength received by the second vehicle access device 30, and/or the elapsed time between sending and receiving the signal or communication between the first vehicle access device 12 and the second vehicle access device 30 to determine the approximate location of the first vehicle access device 12. In other words, a signal received from the first access device 12 may be considered with respect to the location of the second access device 30 when the signal was received. By way of non-limiting examples, the location can be determined by GPS or other specific location data, or the time when the signal was received can be used by the user to determine a location at which they were at that time during the search.

In step 116, the approximate location/area that the first vehicle access device 12 is determined to be in is communicated to the user. For example, the location may be displayed on the user interface 28 of the vehicle 14 or by the external device 16 via the display or speakers of the external device 16. Furthermore, the second vehicle access device 30 may communicate to a user in real time that the first vehicle access device 12 has been detected and/or an approximate location of the first vehicle access device 12 based upon the strength of signal received by the second vehicle access device 30. The second vehicle access device 30 may use sound feedback through a speaker, tactile feedback through a vibrating motor, visual feedback through a display, or the second vehicle access device 30 may communicate to the external device 16 (e.g. a smartphone) to communicate to the user.

Successfully locating the first vehicle access device 12 can be determined in many ways. For example, the located first vehicle access device 12 can be brought into range of the vehicle access device sensor(s) 26 and thereby detected by the sensors 26 (e.g. upon activating an input or function of the first vehicle access device 12), the user may provide confirmation that the first vehicle access device 12 has been successfully located (e.g. via the external device 16, vehicle user interface 28, or by other means), or by other interaction(s) between the first vehicle access device 12 or the user and the vehicle 14. When the control system 22 determines that the first access device 12 has been located, the method 100 ends.

If in step 112, the second vehicle access device 30 fails to detect a communication or signal from the first vehicle access device 12, the method 100 proceeds to step 118. In step 118, the determination that the first access device 12 was not found in the search is communicated to the user. This may involve communication between the second vehicle access device 30, the external device 16, the remote server 18, and/or the vehicle communication device 24 as previously described in steps 112-116. After communicating to the user that the vehicle access device 12 was not located, the method 100 ends, or the user may move to a different location and conduct another search.

Thus, the systems 10 and methods 100 disclosed herein help people find lost key fobs or other vehicle access devices 12. In one example, a key fob 12 is lost and a second key fob 30 is used to try and locate the lost key fob 12. Both key fobs 12, 30 may emit unique codes or other information within signal emissions to permit the key fobs 12, 30 to be distinguished from each other. Both key fobs 12, 30 are registered for use with the vehicle 14 and both are capable of communicating with each other in some form and to some extent (e.g. sending signals to and receiving signals from each other). This mutual communication can be used to help locate the lost key fob 12 as noted herein.

To use the second key fob 30 to find the lost key fob 12, the second key fob 30 is carried by a user as the user moves through a search area while periodically actuating an input of the second key fob 30. Such actuation causes the second key fob 30 to emit a signal that can be received/detected by the lost key fob 12 if the lost key fob 12 is within range of the signal transmission. If the lost key fob 12 receives such a signal, the lost key fob 12 sends a reply signal that is detectable by the second key fob 30. Within a given search area, several signals may be received by the second key fob 30 and the relative strength of those signals, the elapsed time between sending and receiving the signal or communication, and the location of the second key fob 30 when those signals were received, can be used to determine an area or approximate location of the lost key fob 12. In at least some implementations, the location of the second key fob 30 is determined relative to the location of another device 16 carried by the user during the search, such as a smartphone or other portable electronic device with a location sensor (e.g. GPS). Of course, even with a single communication received by the second key fob 30, an approximate location may be determined (e.g. as a function of the location of the second key fob 30 and a radius equal to the approximate distance of the lost key fob 12 from that location which is determined as a function of the strength of the signal received or the elapsed time between sending and receiving the signal or communication). As noted herein, information relating to the signals received at the second key fob 30 can then be uploaded to a controller/device and that information can be used to determine the approximate location of the lost key fob 12.

While this example specifically refers to key fobs, other vehicle access devices 12, 30 may be used. In the example where an external device 16 (e.g. a portable electronic device), such as a tablet computer or smartphone is used as the second access device 30, the external device 16 may directly inform a user when a signal is received from the lost vehicle access device 12 without requiring information about the signal from the lost vehicle access device 12 being uploaded to a different controller or device. This may simplify finding the lost vehicle access device 12 as a user may be guided toward the lost vehicle access device 12 based on increasing or decreasing signal strengths received or the elapsed time between sending and receiving the signal or communication as the user moves during the search. The systems 10 and methods 100 help find a lost vehicle access device 12 that may be lost within or outside the vehicle 14, and that may be outside of a working range of the access device sensors 26. When outside of the working range, the access device sensors 26 are unable to receive a signal from the lost vehicle access device 12 and are thus unable to determine the location of the lost vehicle access device 12, so use of the second vehicle access device 30 increases the area that can be searched and facilitates locating a lost vehicle access device 12.

What is claimed is:

1. A method for locating a vehicle access device, the method comprising the steps of:
detecting a signal from a first vehicle access device using a second vehicle access device; and
determining the location of the first vehicle access device as a function of the timing or strength of the signal received at the second vehicle access device.

2. The method of claim 1, wherein the step of detecting a signal from the first vehicle access device is accomplished by either the first vehicle access device or the second vehicle access device sending a wireless communication and the other of the first vehicle access device or the second vehicle access device receiving the wireless communication.

3. The method of claim 2, wherein the wireless communication is one or more of cellular, ultra-wideband (UWB), WiFi, satellite communications, radio, or Bluetooth.

4. The method of claim 1, wherein determining the location of the first vehicle access device is at least partially based on the time the signal was detected by the second vehicle access device, the time the signal was sent by the first vehicle access device, the strength of the signal detected by the second vehicle access device, the location of the second vehicle access device at the time the signal is detected by the second vehicle access device, or a combination of two or more of the time the signal was detected by the second vehicle access device, the time the signal was sent by the first vehicle access device, the strength of the signal detected by the second vehicle access device, the location of the second vehicle access device at the time the signal is detected by the second vehicle access device.

5. The method of claim 4, wherein the location of the second vehicle access device is determined using the location of an external device.

6. The method of claim 1, wherein subsequent to the step of determining the location of the first vehicle access device, the method further comprises a step of communicating the location of the first vehicle access device.

7. The method of claim 6, wherein the step of communicating the location of the first vehicle access device includes visually, audibly, or tactilely communicating the location of the first vehicle access device through an external device, the second vehicle access device, or a user interface of a vehicle.

8. The method of claim 1, wherein prior to detecting a signal from the first vehicle access device using a second vehicle access device, the first vehicle access device is determined to not be near or within a vehicle by one or more access device sensors.

9. The method of claim 1, wherein when in either the step of detecting a signal from the first vehicle access device using a second vehicle access device or the step of determining the location of the first vehicle access device, the signal is not detected by the second vehicle access device or the location of the first vehicle access device cannot be determined, the method further comprises a step of communicating that the location of the first vehicle access device could not be determined.

10. The method of claim 9, wherein the step of communicating that the location of the first vehicle access device could not be determined includes visually, audibly, or tactilely communicating that the location of the first vehicle access device could not be determined through an external device, the second vehicle access device, or a user interface of a vehicle.

11. A method for locating a vehicle access device, the method comprising the steps of:
prompting a search for a first vehicle access device;
determining a previous known location of the first vehicle access device;
determining if a signal from the first vehicle access device is detected by an access device sensor of a vehicle;
when a signal is not detected from the first vehicle access device, detecting a signal from the first vehicle access device using a second vehicle access device; and
determining the location of the first vehicle access device as a function of the signal received by the second vehicle access device.

12. The method of claim 11, wherein prompting a search for the first vehicle access device is done by a user or by a control system of the vehicle.

13. The method of claim 12, wherein the control system may prompt the search for the first vehicle access device based at least partially on door position of the vehicle, window position of the vehicle, drivetrain position of the vehicle, or ignition position of the vehicle.

14. The method of claim 11, wherein determining a previous known location of the first vehicle access device includes storing GPS coordinates in a memory of a control system where the first vehicle access device and an access device sensor or the first vehicle access device and a second vehicle access device previously communicated.

15. The method of claim 11, wherein the step of detecting a signal from a first vehicle access device using a second vehicle access device is accomplished by either the first vehicle access device or the second vehicle access device sending wireless communication and the other of the first vehicle access device or the second vehicle access device receiving wireless communication.

16. The method of claim 15, wherein the wireless communication is one or more of cellular, WiFi, ultra-wideband (UWB), satellite communications, radio, or Bluetooth.

17. The method of claim 11, wherein determining the location of the first vehicle access device is at least partially based on strength of the signal received by the second vehicle access device.

18. The method of claim 17, wherein determining the location of the first vehicle access device is at least partially based on the time the signal was detected by the second vehicle access device, the time the signal was sent by the first vehicle access device, the strength of the signal detected by the second vehicle access device, or the location of the second vehicle access device at the time the signal is detected by the second vehicle access device.

19. The method of claim 11, wherein subsequent to the step of determining the location of the first vehicle access device, the method further comprises a step of communicating the location of the first vehicle access device.

20. The method of claim 19, wherein the step of communicating the location of the first vehicle access device includes visually, audibly, or tactilely communicating the location of the first vehicle access device through an external device, the second vehicle access device, or a user interface of a vehicle.
